(19) United States
(12) Patent Application Publication
(10) Pub. No.: US 2003/0063852 A1
(43) Pub. Date: Apr. 3, 2003

(54) Method of collimation

(76) Inventors: Zeev Schiffer, Petach Tikva (IL); Sven Ring, Tel Aviv (IL)

Correspondence Address: LASERCOMM, INC., INTELLECTUAL PROPERTY DEPT., 2600 TECHNOLOGY DRIVE SUITE 900, PLANO, TX, 75074, US

(21) Appl. No.: 10/219,350

(22) Filed: Aug. 16, 2002

Related U.S. Application Data
(60) Provisional application No. 60/325,187, filed on Sep. 28, 2001.

(51) Int. Cl. G02B 6/32

(52) U.S. Cl. 385/33

(57) ABSTRACT

An apparatus and method for optimizing the collimation of the output of an optical fiber through a collimating lens, comprising placing the beam through a collimating lens, and then comparing a characteristic feature of the image to a calculated reference image. In one embodiment a side lobe, or non-central local maximum is used as the characteristic feature. The invention is ideally suited for use with a few-mode fiber, and may be utilized for a single mode fiber with the addition of an appropriate optical element between the lens and the observing point. The calculated reference image in one embodiment is calculated assuming an ideal lens and optical element, or in another embodiment a measured optical element is utilized. In another embodiment the calculated reference image is adjusted to optimize the performance of the optical assembly for a specific operating criteria or a combination of criteria. Such criteria include optical attenuation, wavelength dependent loss and the extinction ratio of specific unwanted modes.

CROSS-REFERENCE TO RELATED APPLICATIONS

The present application claims the benefit of the filing date of co-pending U.S. provisional application, S/No. 60/325,187 filed Sep. 28, 2001, entitled “METHOD OF COLLIMATION”.

### BACKGROUND OF THE INVENTION

The invention relates generally to the field of fiber optics, and more specifically to a method and apparatus for collimation of a light beam exiting an optical fiber.

Optical fiber has become increasingly important in many applications involving the transmission of light. When a beam of light is transmitted through an optical fiber, the energy follows a number of paths which are called modes. A mode is a spatially invariant electric field distribution along the length of the fiber. The fundamental mode, also known as the LP₀₁ mode, is the mode in which light passes substantially along the fiber axis. Modes other than the LP₀₁ mode, are known as high order modes. Fibers which have been designed to support with minimal loss only one mode, the LP₀₁ mode, are known as single mode fibers. A multi-mode fiber is a fiber whose design supports multiple modes, and typically supports over 100 modes. A few-mode fiber is a fiber designed to support only a very limited number of modes. For the purpose of this patent, we will define a few mode fiber as a fiber supporting fewer than 20 modes at the operative waveband. Fibers may carry different numbers of modes at different wavelengths, however in telecommunications the typical wavelengths are near 1310 nm and 1550 nm.

Light transmitted through an optical fiber can also be subject to different types of optical interactions to filter, change the mode, modulate, split, combine, or otherwise act on the light. In most cases two or more fibers are led into an enclosure operating as an optical system. The input light entering the enclosure, usually but not always on one fiber, interacts with some optical device within the enclosure, and the resulting light exits the enclosure via one or more fibers. One example of a two port system is a transverse mode transformer as described in U.S. Pat. No. 6,404,951 whose contents are incorporated by reference.

In practice the light exiting the fiber is typically collimated by a lens, such as a GRIN lens or an aspherical lens as the first step in the desired optical interaction. The distance between the end of the fiber and the lens is adjusted to arrive at the desired collimation point, following which the fiber location is secured by applying an adhesive or by laser welding. In some applications the desired point is defined as when the beam is focused to a minimum spot size at a predetermined distance, or a combination of beam size and beam divergence at some predetermined distance. In still other applications the beam is collimated in the far field, by adjusting for a minimum spot size. In practice however, a range of distances between the end of the fiber and the lens arrive at a minimum spot size. In some optical systems, most notable a transverse mode transformer, extremely precise collimation is desired.

In some optical systems a phase element is utilized. A phase element is an optical element which imparts a predetermined phase shift or phase change to a specific segment of the wavefront propagating through the element.

U.S. Pat. No. 6,168,319 describes a method and apparatus of aligning a collimator assembly requiring only a single-axis adjustment and for which the collimator may be paired with any other similarly aligned collimator. The position of the ferrule/fiber is adjusted within a tube while the size of the resultant beam is measured at a fixed distance from the output of the lens. In practice such a method is ideally suited to a single mode fiber, which contains only the LP₀₁ mode with a Gaussian shape. The collimation of the output of a few mode fiber, and particularly one which predominantly consists of a single high order mode, can not be optimized with a high degree of accuracy utilizing spot size.

Thus there is a need for a method and apparatus for aligning a collimator assembly suitable for use with a fiber carrying predominantly a single high order mode.

### SUMMARY OF THE INVENTION

Accordingly, it is a principal object of the present invention to overcome the disadvantages of prior art methods of aligning a collimator assembly. This is provided in the present invention by utilizing a numerical analysis of the expected intensity pattern, measuring the location of characteristic features of the expected intensity pattern at a pre-determined distance, and comparing the characteristic features of the received beam with the expected pattern.

In an exemplary embodiment the invention comprises a method of optimizing collimation of the output of an optical fiber comprising the steps of: supplying an end of an optical fiber and a lens in optical communication with the end of the optical fiber; calculating an expected reference image, the expected reference image having at least one characteristic feature not present in the output of single mode fiber; observing the output of the lens and calculating the differential between the location of the characteristic feature in the output and the expected reference image. The end of the optical fiber is then moved in relation to the lens so as to minimize the differential, thus optimizing the collimation.

In one embodiment the fiber comprises a few mode fiber, while in another embodiment the output is observed at a distance greater than the Fraunhofer zone, while in yet another embodiment the output is observed at a distance less than the Fraunhofer zone. In another embodiment the characteristic feature comprises a side lobe, or a non-central local maximum.

In one embodiment the reference image is adjusted to achieve a minimal loss for the optical subsystem for which the optical fiber and lens are a part. In another embodiment the reference image is adjusted to achieve a minimal wavelength dependent loss for the optical subsystem for which the optical fiber and lens are a part. In yet another embodiment the reference image is adjusted to achieve a maximal extinction ration for a specific undesired mode.

In a preferred embodiment an additional optical element is placed in the optical path, and the output of the optical element is observed. Further preferably the optical element comprises a phase element. Still further preferably the fiber comprises a single mode fiber, and the characteristic feature is a function of the optical element. In further embodiment the reference image is a function of the designed values of an optical element, while in another further embodiment the reference image is a function of a measured actual optical element. In another further embodiment the characteristic feature comprises a side lobe, or a non-central local maximum.

The invention also comprises an apparatus for optimizing collimation at the output of an optical fiber through a lens. The apparatus comprises an end of an optical fiber, a lens in optical communication with the end of the optical fiber; a means of observing the output of the lens and a computer comprising an expected reference image, the expected reference image having at least one characteristic feature not present in the output of single mode fiber. The difference between the location of the characteristic feature in the output and the location of the characteristic feature of the expected reference image is calculated by the computer and the end of the optical fiber is moved in relation to the lens so as to minimize the differential, thus optimizing the collimation.

In one embodiment the fiber comprises a few mode fiber. In another embodiment the output is observed at a distance greater than the Fraunhofer zone, while in yet another embodiment the output is observed at a distance less than the Fraunhofer zone. In one embodiment the reference image is adjusted to achieve a minimal loss for the optical subsystem for which the optical fiber and lens are a part. In another embodiment the reference image is adjusted to achieve a minimal wavelength dependent loss for the optical subsystem for which the optical fiber and lens are a part. In yet another embodiment the reference image is adjusted to achieve a maximal extinction ration for a specific undesired mode. In another embodiment the characteristic feature comprises a side lobe, or a non-central local maximum.

In a preferred embodiment the apparatus further comprises an optical element. In a still further embodiment the optical element comprises a phase element. In still another further embodiment the fiber comprises a single mode fiber, and the characteristic feature is a function of the optical element.

In one further embodiment the reference image is a function of the designed values of an optical element, while in another further embodiment the reference image is a function of a measured actual optical element. In another further embodiment the characteristic feature comprises a side lobe, or a non-central local maximum.

Additional features and advantages of the invention will become apparent from the following drawings and description.

### BRIEF DESCRIPTION OF THE DRAWINGS

The above and further advantages of this invention may be better understood by referring to the following description taken in conjunction with the accompanying drawings in which like numeral designate corresponding elements or sections throughout, and in which:

FIG. 1 illustrates a high level block diagram of a setup useful in launching a high order mode into a fiber;

FIG. 2 illustrates a high level block diagram of a setup useful in aligning the collimation for a high order mode in accordance with the invention;

FIG. 3 illustrates a high level diagram of a releasable ferrule holder as shown in FIG. 1 and FIG. 2;

FIG. 4 illustrates a calculation of the expected image of the LP₀₂ mode in an embodiment of the invention;

FIG. 5 illustrates a high level flow chart of a program used to compare a characteristic feature of the image with a characteristic feature of the expected image;

FIG. 6 illustrates a plot of ferrule position vs. difference in location of the characteristic feature in an embodiment of the invention;

FIG. 7 illustrates an expected image vs. an actual image for an improperly collimated lens;

FIG. 8 illustrates an expected image vs. an actual image for a properly collimated lens; and

FIG. 9 illustrates a high level block diagram of a collimator for a single mode fiber to which optical elements have been added.

### DETAILED DESCRIPTION OF THE PREFERRED EMBODIMENTS

The invention allows for the alignment of a collimator comprising a dominant high order mode using image processing.

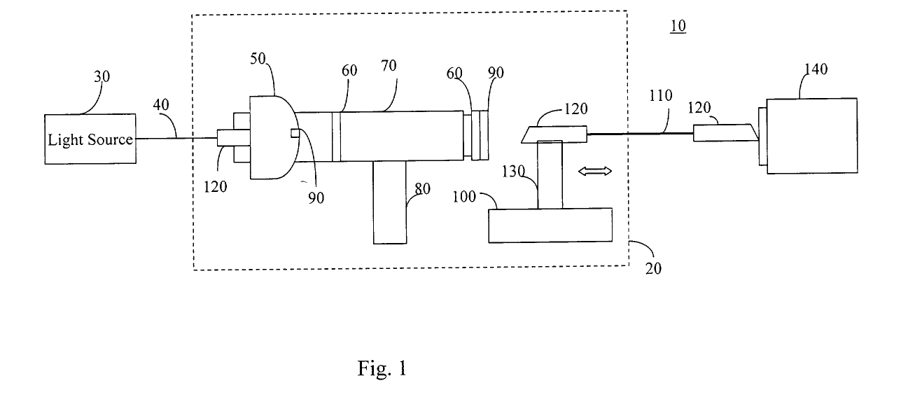

FIG. 1 illustrates a high level block diagram of an exemplary embodiment of a setup 10 useful for effectively launching a high order mode into a few mode fiber and comprises light source 30, single mode fiber (SMF)40, open mode converter 20, ferrule 120, few mode fiber 110 and power meter 140. Open mode converter 20 comprises SMF 40, collimator housing 50, phase elements 60, tube 70, collimating lens 90, holder 80, stage 100, few mode fiber 110, ferrule 120 and releasable holder 130. The output of light source 30 is connected to one end of SMF 40, and the other end of SMF 40 enters the input of open mode converter 20 and is terminated in first ferrule 120 (partially shown) secured within collimator housing 50. First lens 90 is secured within collimator housing 50 so as to collimate the light exiting SMF 40. Phase elements 60 are secured in tube 70 so as to ensure proper placement and alignment with respect to collimator housing 50 and in particular first lens 90, and one end of tube 70 is secured to collimator housing 50. Second lens 90, contained within a housing (not shown) is secured to the other end of tube 70 and tube 70 is secured by holder 80 to a firm surface, such as an optical table. Second ferrule 120 is secured in releasable holder 130 and releasable holder 130 is secured to a firm surface, such as an optical table, by movable stage 100. A first end of few mode fiber 110 is terminated by second ferrule 120, which is secured in releasable holder 130. Few mode fiber 110 exits open mode converter 20 and its second end is terminated at third ferrule 120. The output of the second end of few mode fiber 110 is connected as the optical input to power meter 140.

In an exemplary embodiment, light source 30 comprises a laser emitting light at the operational bandwidth of the device to be aligned, for example a laser diode emitting at 1550 nm. Further in an exemplary embodiment, the collimator housing 50 is of the type described in U.S. Pat. No. 6,340,248, whose contents are incorporated by reference, however any collimator of sufficient precision may be utilized. Phase elements 60 are designed to selectively alter the phase of a portion of the wavefront so as to accomplish a mode transformation in a manner as described in U.S. Pat. No. 6,404,951.

In operation, first lens 90 is secured within collimator housing 50, and is aligned using standards methods known in the prior art. First lens 90 and phase elements 60 act to create a focused image of the desired mode to be launched at the focal point of second lens 90. The invention will be described in relation to a few-mode fiber, however this is not meant to be limiting in any way. The invention is equally applicable to a single mode fiber, and to a fiber carrying more modes than the modes supported by a few mode fiber. The limiting factor is only that the theoretical mode shape must be known. The ends of few mode fiber 10 are secured within second and third ferrule 120 in a manner known to those skilled in the art, and polished to a predetermined facet angle (for example 8°) to prevent back reflection along the optical axis. Second ferrule 120 is secured in holder 130, which is designed for easy installation and removal of ferrule 120, and in one embodiment consists of a threaded connector such as an FC/APC. Holder 130 is secured to a firm surface, such as an optical table, by movable stage 100, which allows for fine positioning in all axes and angles, for a total of 5 degrees of freedom, of ferrule 120. The initial placement of ferrule 120 in holder 130 is designed to be at the focal point of second lens 90. The second end of few mode fiber 110 is secured within third ferrule 120 in a manner known to those skilled in the art, and polished to a predetermined facet angle (for example 8°) to prevent back reflection along the optical axis. Stage 100 is moved in micron steps in all three axes thereby positioning the first end of few mode fiber 110 to arrive at a maximum reading on the power meter, which is indicative of minimum loss. Once a minimum loss point is achieved, a high order mode, such as the LP₀₂ mode, is being dominantly launched into the first end of few mode fiber 110. The second end of fiber 110 will thus exhibit primarily the dominant LP₀₂ mode, however other modes, notably the fundamental or LP₀₁ mode will also be present to a small extent. The second end of few mode fiber 110 is then disconnected from power meter 140.

The system will be described in connection with a specific high order mode, the LP₀₂ mode. However it is to be understood that any high order mode can be aligned for, including but not limited to the LP₁₁, LP₀₃, LP₁₂ and LP₂₁ modes. In the event that the mode is an odd mode, that is the intensity does not peak at the center, a minimum energy point at the center is substituted for the described maximum found at the center of the even mode. Alignment may also be accomplished in the case of more than one mode, with the limiting factor being the need for a theoretical calculation of the expected image shape.

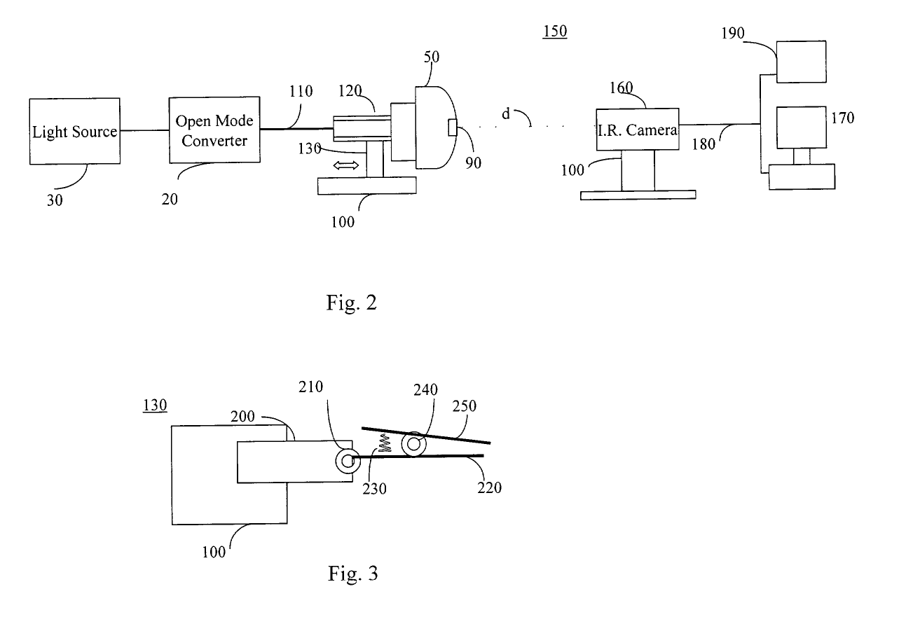

FIG. 2 illustrates a high level block diagram of an exemplary embodiment of a setup 150 useful in aligning the collimator of a few mode fiber, comprising light source 30, open mode converter 20, few mode fiber 110, ferrule 120, releasable holder 130, collimator housing 50, lens 90, infrared camera 160, movable stages 100, data connection 180, monitor 190 and computer 170. Light source 30 is connected to the input of open mode converter 20, and the output of open mode converter 20 comprises a first end of few mode fiber 110, as described above in relation to FIG. 1. The second end of few mode fiber 110 is secured within a ferrule 120, which is inserted into a collimator housing 50 and secured by holder 130 to first movable stage 100. Lens 90 is secured in collimator housing 50, and the output light from lens 90 is directed over distance d to the optical input of infrared camera 160. Infrared camera 160 is secured to second movable stage 100. The electrical output of infrared camera 160 is connected by connection 180 to computer 170, and monitor 190 is connected to infrared camera 160 and computer 170.

In operation light source 30 is connected as in FIG. 1 above to one end of SMF 40 whose other end acts as the input to open mode converter 20. Open converter 20 acts as described in relation to FIG. 1 above, to launch predominantly a single high order mode into the first end of few mode fiber 110. Holder 130 is secured to first movable stage 100, which in one embodiment is adapted to allow only for single axis movement, and first movable stage 100 is secured to a firm surface such as an optical table (not shown). The single axis movement allows for modifying the depth of insertion of the ferrule 120 into the collimator housing 50. Modifying the depth of insertion of the ferrule 120 modifies the location of the tip of fiber 110 in relation to the collimating lens 90 located in collimator housing 50.

Infrared camera 160 is secured to second movable stage 100, and is secured at a fixed known distance, d, from lens 90 in collimator housing 50. In one embodiment the distance is 53 centimeters. The precise distance utilized must be known, and is preferably past the beginning of the Fraunhopfer zone, indicating that the field seen by infrared camera 160 is the far field. In another embodiment the near field is utilized, and an additional optical element such as a phase element or a lens (not shown) is required. In an exemplary embodiment, second movable stage 100 is adjustable in the x-axis and y-axes, so as to properly align infrared camera 160 with the output light exiting lens 90 of collimator housing 50. The distance d, however should not be changed. As a first approximation a hand held infrared sensor card is utilized, and second movable stage 100 is adjusted to approximately center the beam on the camera. In practice, once an initial location for second movable stage 100 is found, any changes in the beam location caused by adjusting the position of ferrule 120 in collimator housing 50 are typically compensated for by software. The distance between the second end of few mode fiber 110 and lens 90 is adjusted by moving first stage 100 in the z-axis, and the image observed by infrared camera 160 is fed to computer 170 by connection 180 which processes the image and compares the image to a reference as will be further described below. In an exemplary embodiment connection 180 comprises a network connection or a direct connection such as an RS-232 port connection. Computer 170 may be a personal computer, workstation or other general computing device such as a microcomputer, microprocessor or mainframe computer, or any other computing platform all without exceeding the scope of the invention.

The image seen by infrared camera 160 is displayed on monitor 190 and is used to maintain the center of the beam location on the center of infrared camera 160, and to allow the operator to find the best match between the captured image and a reference image, as will be described further below. In another embodiment, the monitor is not utilized and a computerized algorithm finds the center of the image and finds a best match with a reference image. Once the proper location is found, ferrule 120 is secured in collimator housing 50 utilizing known methods such as laser welding or by applying an adhesive. The completed assembly is thus properly collimated and may be removed from holder 130.

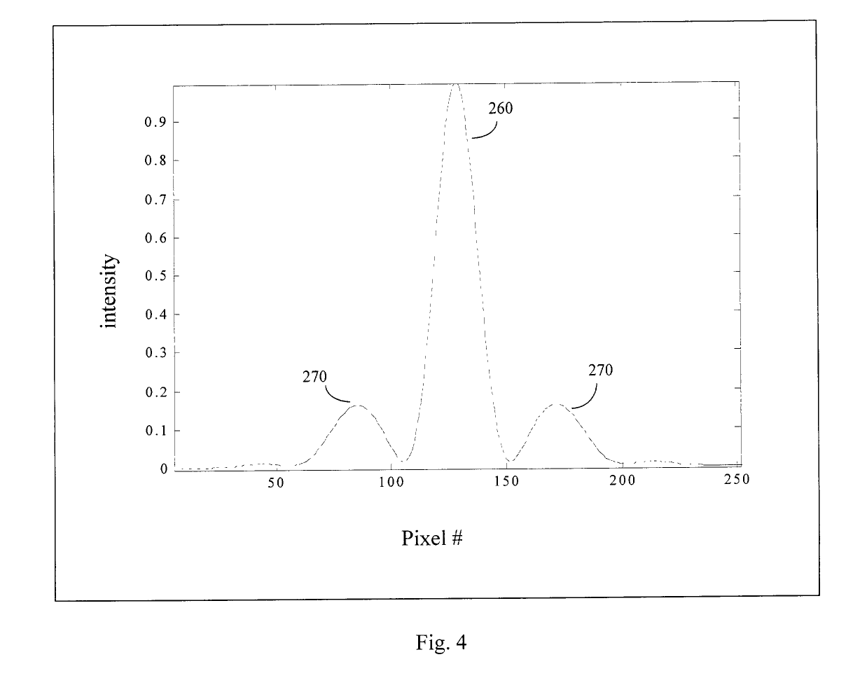

FIG. 3 illustrates a high level diagram of an embodiment of releasable holder 130 comprising stage 100, fixed portion 200, first pivot 210, stationary arm 220, spring 230, second pivot 240 and movable arm 250. Fixed portion 200 is secured to stage 100, and stationary arm 220 is pivotally secured to fixed portion 200 by first pivot 210. Movable arm 250 is pivotally connected to stationary arm 220 by second pivot 240, and is urged towards the closed position by spring 230. Preferably pivot 210 is a tightened pivot, such that stationary 220 is not easily movable, however it can be pivoted with sufficient force. Ferrule 120 is secured by opening movable arm 250, placing ferrule 120 in place against stationary arm 200, and releasing movable arm 220, which is then urged by spring 230 towards movable arm 220 securing ferrule 120. Pivot 210 is supplied for ease of loading of ferrule 120.

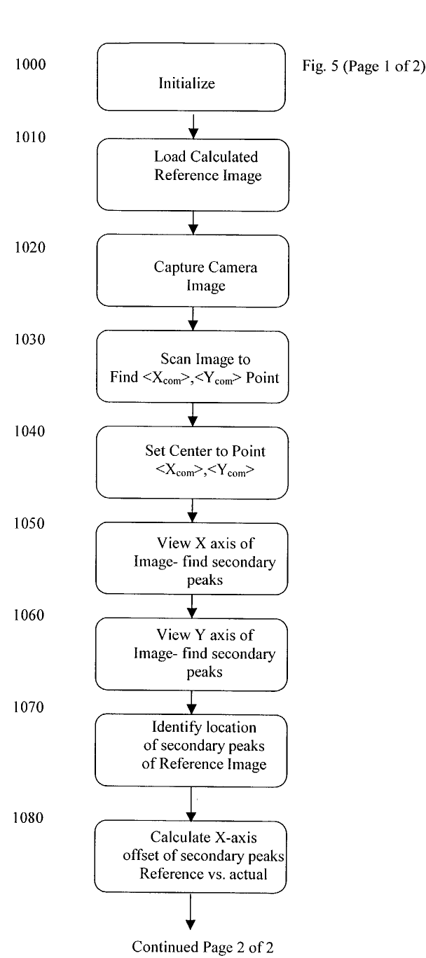

FIG. 4 illustrates a calculated reference image in which the x-axis represents pixel number and the y-axis represents normalized intensity. The reference image was calculated utilizing an angular spectrum method, known to those skilled in the art, in which the propagation of the theoretical field to the camera is calculated taking into account among other things the pixel size of the camera. Other methods of calculating the reference image may be utilized as known to those skilled in the art, the image of a “gold sample” may be utilized or an image based on a large sampling of “good” units may be utilized without exceeding the scope of the invention. The image of FIG. 4 shows a cross section of an LP₀₂ mode as calculated based on the actual profile of few mode fiber 110, after propagation through lens 90 and the distance, d, between lens 90 and the camera 160. The LP₀₂ mode exhibits a central peak 260, and symmetric side peaks 270. One realization of the present invention is that in an actual image containing the LP₀₂ mode as the primary mode, where other modes are present, the height and shape of the central peak 260 need not be consistent with the calculated image. However the location of the secondary symmetric peaks 270, which are based on transmission of the actual desired mode, do not change appreciably because of the existence of other modes.

As indicated above, the system is being described in connection with a specific high order mode, the LP₀₂ mode. However it is to be understood that light exiting in any high order mode can be collimated using the invention, including but not limited to the LP₁₁, LP₀₃, LP₁₂ and LP₂₁ modes. For the desired mode a characteristic that is invariant in location due to the presence of other modes is utilized. Preferably the characteristic is substantially at a point where other present modes are negligible. This will typically comprise the location of a specific side lobe or local maximum or minimum point away from the center. Alignment may also be accomplished in the case of more than one mode, with the limiting factor being the need for a theoretical calculation of the expected image shape, and finding a characteristic such as a peak or minima whose location is unchanged despite the presence of multiple modes.

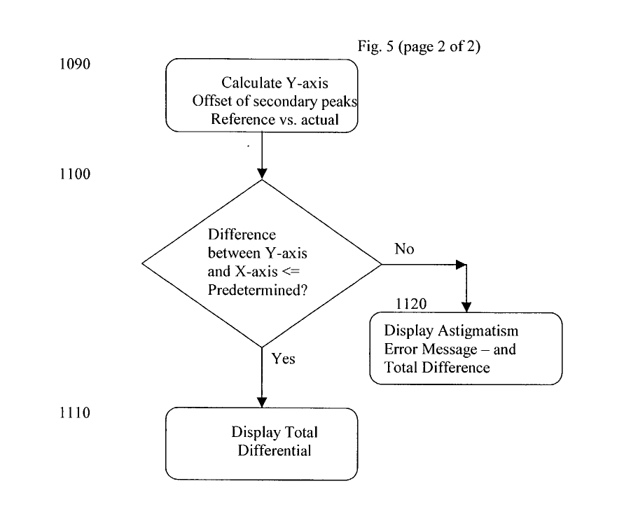

FIG. 5 illustrates a high level flow chart of a program suitable to run on computer 170 for finding the optimum collimation point while moving ferrule 120 of FIG. 2. In step 1000 the system is initialized, and in step 1010 the calculated reference image is loaded. Preferably the calculated reference image is a vector of values with its maximum at the center of the expected far field image. In step 1020 the image from infrared camera 160 is captured and stored. In step 1030 the image is scanned to find the center of mass of the pattern. The x-coordinate of the center of mass is defined as:

$$⟨ {X}_{com} ⟩ = \frac{{\sum }_{m , n} {f}^{6} ( x , y ) * x}{\sum {f}^{6} ( x , y )} \qquad Equation \text{1a}$$

where m,n are the coordinates of the pixels, and f is the value of each pixel. The 6^{th} power is utilized so as to arrive at the center of the mass of the center peak, without taking into account the side lobes. In the event the mode does not have a center peak, the center of the mass of the entire object is utilized. Similarly the y coordinate of the center of mass is defined as:

$$⟨ {Y}_{com} ⟩ = \frac{{\sum }_{m , n} {f}^{6} ( x , y ) * y}{\sum {f}^{6} ( x , y )} \qquad Equation \text{1b}$$

In step 1040 the center is set to the x,y coordinates of the center of mass. It is to be understood that as ferrule 120 of FIG. 2 is moved the image may shift position on infrared camera 160, and thus the center of the image must be recalculated after each repositioning of the ferrule. In the event that the full image has moved off the camera, second stage 100 is adjusted to bring the image fully onto infrared camera 160.

In step 1050 the x-axis across the center of the actual image is viewed, which as mentioned above has the maximum intensity at its center, and the location of the secondary peaks are found. In step 1060 the y-axis of the image is viewed and the location of the secondary peaks are found. In step 1070 the location of the secondary peaks on the reference image are identified. In step 1080 the offset between the secondary peaks on the x-axis is calculated using the formula:

Δ=Δ_{left}+Δ_{right} Equation 2

where Δ_{left} represents the distance between the reference peak and the captured peak to the left side of the center, and Δ_{right} represents the distance between the reference peak and the captured peak to the right side of the center. In step 1090 the offset between the location of the secondary peaks on the y-axis is calculated using equation 2, and in step 1100 the difference between the calculated values of Δx and Δy are compared. If the differential is greater than a predetermined amount, the program proceeds to step 1120 which displays an astigmatism error message indicating that the image is not sufficiently symmetric. In an exemplary embodiment the predetermined amount is two camera pixels. If the program in step 1100 determines that the differential is no more than the predetermined amount the program proceeds to step 1110, in which the total differential is displayed according to the formula:

Δₜₒₜₐₗ=Δₓ=Δ_{y} Equation 3

The operator moves ferrule 120 from a position which is about 1.5 times larger than the focal distance, towards the lens 90, until a minimum value of Δₜₒₜₐₗ is found.

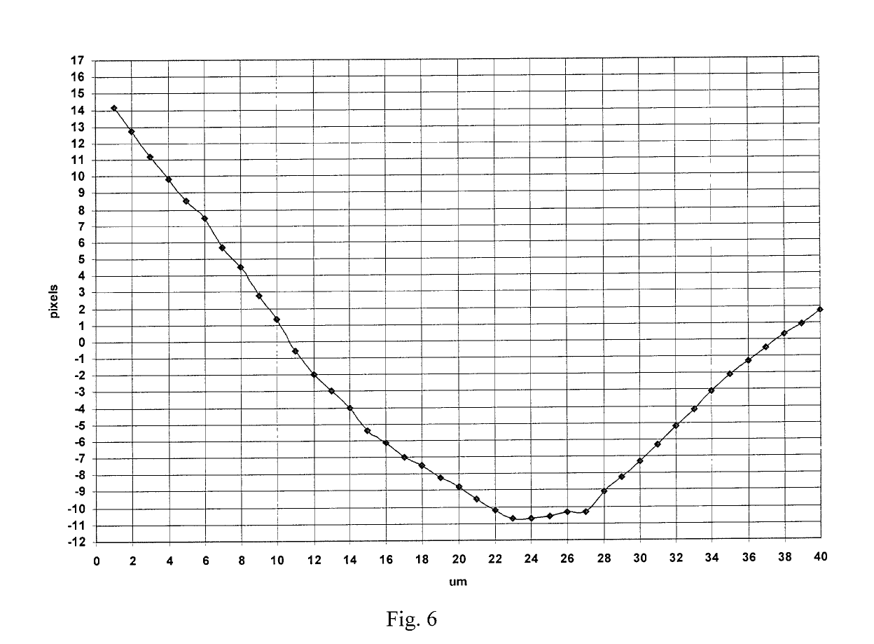

FIG. 6 illustrates an embodiment of a typical curve showing Δₜₒₜₐₗ in which the x-axis represents the position of ferrule 120 in microns, and the y-axis represents Δₜₒₜₐₗ in pixels. It is to be noted that two zero crossings occur, one at approximately 10 microns, with a second zero crossing at approximately 38 microns. The first minimum in the curve must be bypassed in order to find the second minimum which achieves a flat wavefront. The existence of multiple zero crossings is to be confirmed for each setup by calculating the reference image at multiple ferrule locations. The location of the characteristic feature being utilized is then noted, and if multiple coincident locations of the characteristic are found, the proper zero crossing position giving an ideal wavefront is utilized. In the exemplary embodiment utilizing the LP₀₂ mode, it is the second zero crossing closest to the lens which represents a flat wavefront.

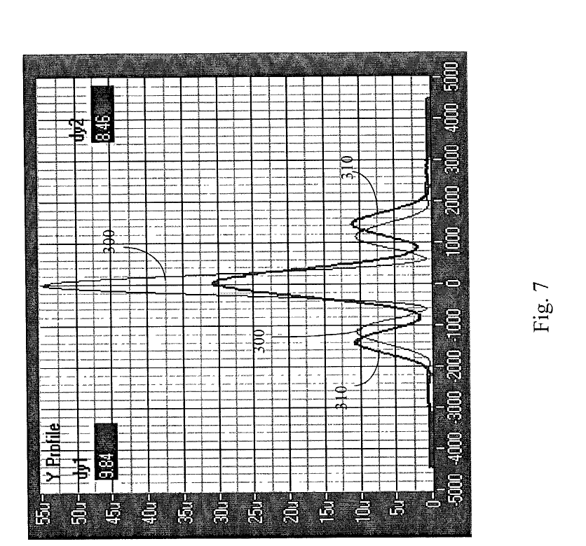

FIG. 7 displays an image of the reference curve 300 against an actual measured curve 310 of an improperly collimated beam. The x-axis indicates the distance in location from the center in microns, and the x-axis indicates the intensity of the beam in arbitrary units. The differential between the location of the secondary peaks is clear, and thus curve 310 is not that of a properly collimated beam.

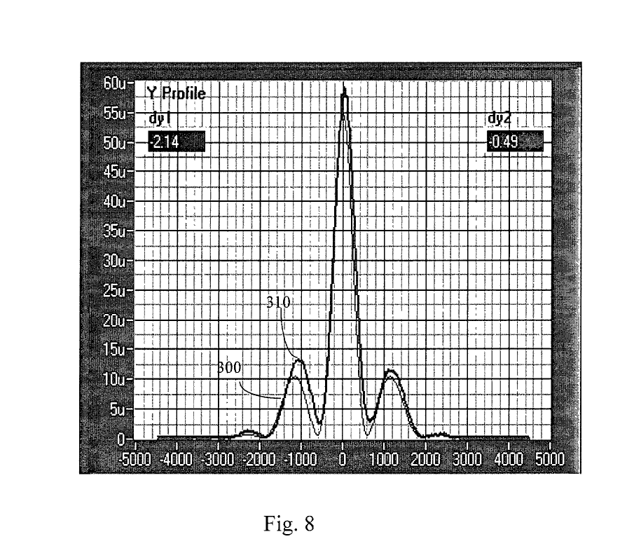

FIG. 8 displays and image of the reference curve 300 against an actual measured curve 310 of a properly collimated beam. The x-axis indicates the distance in location from the center in microns, and the y-axis indicates the intensity of the beam in arbitrary units. The close fit of the secondary peaks indicates that the collimator is properly aligned.

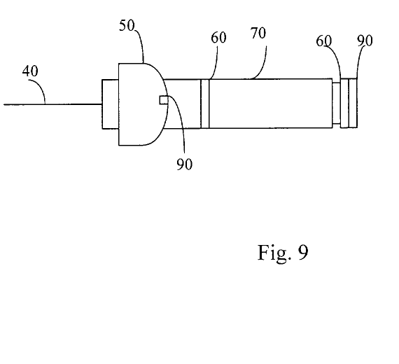

In another embodiment, the above invention is utilized for collimation of a fundamental mode beam of light which does not contain a secondary peak. An optical element, such as a phase element 60 is added to modify the beam so as to generate a unique pattern, containing secondary peaks as will be described further below in relation to FIG. 9. The position of those secondary peaks are then utilized in the manner described above.

FIG. 9 illustrates a collimator assembly to which has been added phase elements, and comprises single mode fiber (SMF) 40, collimator housing 50, phase elements 60, tube 70 and collimating lens 90. The expected output of the assembly of FIG. 9 can be calculated given the shape of the curves of phase elements 60, the length of tube 70 and the shapes of the collimating lens 90. This expected output is utilized as the reference image loaded in step 1010 of the program of FIG. 5. Utilizing such a construct allows for the use of the inventive method herein described with a single mode fiber.

The above invention has been described in relation to a calculated reference image. In an exemplary embodiment the calculated reference image takes into account the propagating modes from the few mode fiber 110, an ideal collimating lens 90 and ideal phase elements 60. In another embodiment, measured phase elements 60 are utilized. In another preferred embodiment the reference image is adjusted based on the desired operational criteria of the subsystem so that collimation is defined as an ideal working point. The operational criteria of the optical subsystem for which the lens and fiber end are utilized comprise a combination of loss, wavelength dependent loss or the amount of optical energy in certain undesired modes.

The above invention has been described in relation to utilizing an infrared camera the means of observing the output. This in not meant to be limiting in any way, and other means including a visible light camera, a far infrared camera, or a wavefront camera. In an embodiment comprising a wavefront camera the reference image may comprise both an intensity and a phase.

The above intention has been described in relation to collimation of the output of a single fiber, however this is not meant to be limiting in any way, and is specifically meant to include utilizing a single optical element to optimize the collimation of each fiber in an array of fibers.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

We claim:

1. A method of optimizing collimation of the output of an optical fiber through a lens comprising the steps of:
supplying an end of an optical fiber;
supplying a lens in optical communication with said end of said optical fiber, said lens being at an initial distance from said end of said optical fiber;
calculating an expected reference image, said expected reference image comprising at least one characteristic feature;
observing the output of said lens, and
calculating the differential between the location of said characteristic feature in said output and said expected reference image, and
moving said end of said optical fiber in relation to said lens so as to minimize said differential thus optimizing the collimation of said output.

2. The method of claim 1 wherein said fiber comprises a few mode fiber.

3. The method of claim 1 wherein said output is observed at a distance greater than the Fraunhofer zone.

4. The method of claim 1 wherein said characteristic feature comprises a non-central local maximum.

5. The method of claim 1 wherein said reference image is adjusted to achieve a minimal loss.

6. The method of claim 1 wherein said reference image is adjusted to achieve a minimal wavelength dependent loss.

7. The method of claim 1 wherein said reference image is adjusted to achieve a maximal extinction ratio for a specific mode.

8. The method of claim 1 further comprising supplying an optical element in optical communication with said lens, and observing the output of said optical element.

9. The method of claim 8 wherein said optical element comprises a phase element.

10. The method of claim 8 wherein said fiber comprises a single mode fiber.

11. The method of claim 8 wherein said characteristic feature comprises a non-central local maximum.

12. The method of claim 8 wherein said reference image is a function of an ideal optical element.

13. The method of claim 8 wherein said reference image is a function of a measured optical element.

14. An apparatus for optimizing collimation of the output of an optical fiber through a lens comprising:
an end of an optical fiber;
a lens in optical communication with said end of said optical fiber, said lens being at an initial distance from said end of said optical fiber;
a means of observing the output of said lens, and
a computer comprising an expected calculated reference image, said expected reference image comprising at least one characteristic feature,
wherein the differential between the location of said characteristic feature in said output and said expected reference image is calculated by said computer, and the end of said optical fiber is moved in relation to said lens so as to minimize said differential thus optimizing the collimation of said output.

15. The apparatus of claim 14 wherein said fiber comprises a few mode fiber.

16. The apparatus of claim 14 wherein said output is observed at a distance greater than the Fraunhofer zone.

17. The apparatus of claim 14 wherein said characteristic feature comprises a non-central local maximum.

18. The apparatus of claim 14 wherein said reference image is adjusted to achieve a minimal loss.

19. The apparatus of claim 14 wherein said reference image is adjusted to achieve a minimal wavelength dependent loss.

20. The apparatus of claim 14 wherein said reference image is adjusted to achieve a maximal extinction ratio for a specific mode.

21. The apparatus of claim 14 further comprising an optical element in optical communication with said lens, wherein the output of said optical element is observed.

22. The apparatus of claim 21 wherein said optical element comprises a phase element.

23. The apparatus of claim 21 wherein said characteristic feature comprises a non-central local maximum.

24. The apparatus of claim 21 wherein said fiber comprises a single mode fiber.

25. The apparatus of claim 21 wherein said reference image is a function of an ideal optical element.

26. The apparatus of claim 21 wherein said reference image is a function of a measured optical element.
